(19) United States
(12) Patent Application Publication
(10) Pub. No.: US 2025/0337510 A1
(43) Pub. Date: Oct. 30, 2025

(54) RECEIVED SIGNAL POWER PREDICTION SYSTEM, RECEIVED SIGNAL POWER PREDICTION APPARATUS, RECEIVED SIGNAL POWER PREDICTION METHOD, AND PROGRAM

(71) Applicant: NIPPON TELEGRAPH AND TELEPHONE CORPORATION, Tokyo (JP)

(72) Inventors: Motoharu SASAKI, Tokyo (JP); Kenichi KAWAMURA, Tokyo (JP); Naoki SHIBUYA, Tokyo (JP); Wataru YAMADA, Tokyo (JP); Minoru INOMATA, Tokyo (JP); Nobuaki KUNO, Tokyo (JP); Takatsune MORIYAMA, Tokyo (JP)

(21) Appl. No.: 18/872,001

(22) PCT Filed: Jul. 6, 2022
(86) PCT No.: PCT/JP2022/026870

§ 371 Date: Dec. 5, 2024

(51) Int. Cl. H04B 17/373; H04W 64/00

(52) U.S. Cl. CPC H04B 17/373; H04W 64/00

(57) ABSTRACT

A received signal power prediction system predicts received signal power of a communication terminal after a predetermined period has elapsed. The received signal power prediction system includes a terminal information acquisition unit configured to acquire an actually measured value of received signal power of the communication terminal and a position of the communication terminal; a terminal position prediction unit configured to predict a predicted position of the communication terminal after the predetermined period has elapsed based on the position of the communication terminal; an estimated value acquisition unit configured to acquire an estimated value of received signal power at the predicted position of the communication terminal; and a received signal power prediction unit configured to predict the received signal power of the communication terminal after the predetermined period has elapsed using the actually measured value of the received signal power and the estimated value of the received signal power.

### TECHNICAL FIELD

The present invention relates to a received signal power prediction system, a received signal power prediction apparatus, a received signal power prediction method, and a program.

### BACKGROUND ART

A technology for predicting wireless communication quality in a wireless communication system is known. For example, there is known a technology for predicting received signal power of a communication terminal on the basis of a past actually measured value of the received signal power at a position, assuming a static environment of an object such as a building or a tree whose position and size do not change in units of seconds as a blocking object.

### CITATION LIST

### Non Patent Literature

Non Patent Literature 1: Keisuke Wakao, Kenichi Kawamura, Takatsune Moriyama, “Quality Prediction Technology for Optimal Use of Multiple Wireless Access Networks”, NTT Technical Journal, April 2020, p. 11-13

### SUMMARY OF INVENTION

### Technical Problem

However, in the related art, for example, in a dynamic environment where a moving object such as a person, a vehicle, or a robot exists, it is difficult to predict received signal power of a communication terminal in consideration of blocking of radio waves by the moving object.

An embodiment of the present invention has been made in view of the above problem and provides a received signal power prediction system capable of predicting received signal power of a communication terminal in consideration of blocking of radio waves by a moving object in a dynamic environment where the moving object exists.

### Solution to Problem

In order to solve the above problem, a received signal power prediction system according to an embodiment of the present invention is a received signal power prediction system that predicts received signal power of a communication terminal after a predetermined period has elapsed, the received signal power prediction system including: a terminal information acquisition unit configured to acquire an actually measured value of received signal power of the communication terminal and a position of the communication terminal; a terminal position prediction unit configured to predict a predicted position of the communication terminal after the predetermined period has elapsed based on the position of the communication terminal; an estimated value acquisition unit configured to acquire an estimated value of received signal power at the predicted position of the communication terminal; and a received signal power prediction unit configured to predict the received signal power of the communication terminal after the predetermined period has elapsed using the actually measured value of the received signal power and the estimated value of the received signal power.

### Advantageous Effects of Invention

According to the embodiment of the present invention, it is possible to provide a received signal power prediction system capable of predicting received signal power of a communication terminal in consideration of blocking of radio waves by a moving object in a dynamic environment where the moving object exists.

### BRIEF DESCRIPTION OF DRAWINGS

FIG. 1 is a view illustrating an example of a system configuration of a received signal power prediction system according to the present embodiment.

FIG. 2 is a view for explaining outline of pre-processing according to the present embodiment.

FIG. 3 is a view for explaining outline of received signal power prediction processing according to the present embodiment.

FIG. 4 is a view illustrating another example of the system configuration of the received signal power prediction system according to the present embodiment.

FIG. 5 is a flowchart indicating an example of pre-processing according to Example 1.

FIG. 6 is a flowchart indicating an example of received signal power prediction processing according to Example 1.

FIG. 7 is a view for explaining received signal power prediction processing using an RNN according to Example 1.

FIG. 8 is a view for explaining time-series data of an estimated value of received signal power according to Example 1.

FIG. 9 is a view illustrating an example of a prediction result of received signal power after a predetermined period has elapsed according to the present embodiment.

FIG. 10 is a view for explaining an example of received signal power prediction processing using an RNN according to Example 2.

FIG. 11 is a flowchart indicating an example of received signal power prediction processing according to Example 3.

FIG. 12 is a view illustrating an example of a hardware configuration of a received signal power prediction apparatus according to the present embodiment.

FIG. 13 is a view illustrating an example of a hardware configuration of a communication terminal according to the present embodiment.

FIG. 14 is a view (1) for explaining a subject in the present embodiment.

FIG. 15 is a view (2) for explaining a subject of the present embodiment.

### DESCRIPTION OF EMBODIMENTS

An embodiment of the present invention (present embodiment) will be described below with reference to the drawings. The embodiment to be described below is merely an example, and embodiments to which the present invention is applied are not limited to the following embodiment.

### <System Configuration>

A received signal power prediction system 1 according to the present embodiment is a system in which a communication terminal (wireless terminal) predicts received signal power received from a base station (wireless base station) after a predetermined period has elapsed in a wireless communication network.

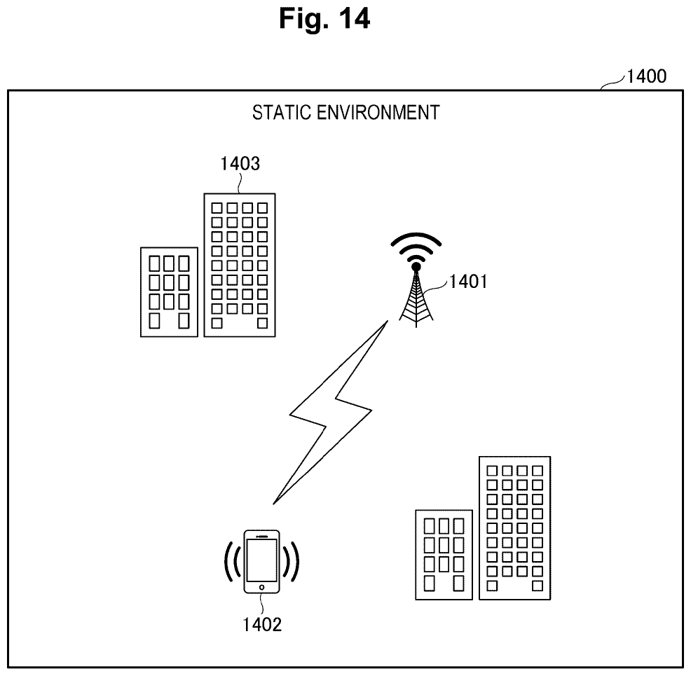

A quality prediction system in related art as described in Non Patent Literature 1, for example, predicts wireless communication quality from an actually measured value of communication quality at an evaluation point acquired in advance, a current position of a communication terminal, movement information of the communication terminal, and the like. According to this related art, for example, as illustrated in FIG. 14, in a static environment 1400 in which only stationary objects such as a building 1403 exist, received signal power received by a communication terminal 1402 from a base station 1401 can be predicted based on the actually measured value of the received signal power acquired in advance.

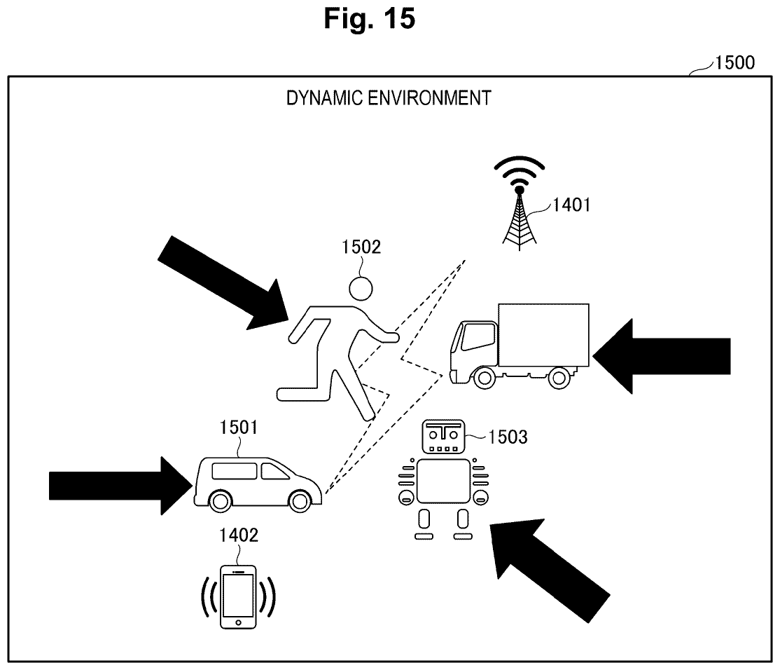

However, in this method, as illustrated in FIG. 15, in a dynamic environment 1500 in which moving objects such as a vehicle 1501, a person 1502, and a robot 1503 exist, radio waves are blocked by the moving objects, and thus, it is difficult to predict received signal power received by the communication terminal 1402 from the base station 1401.

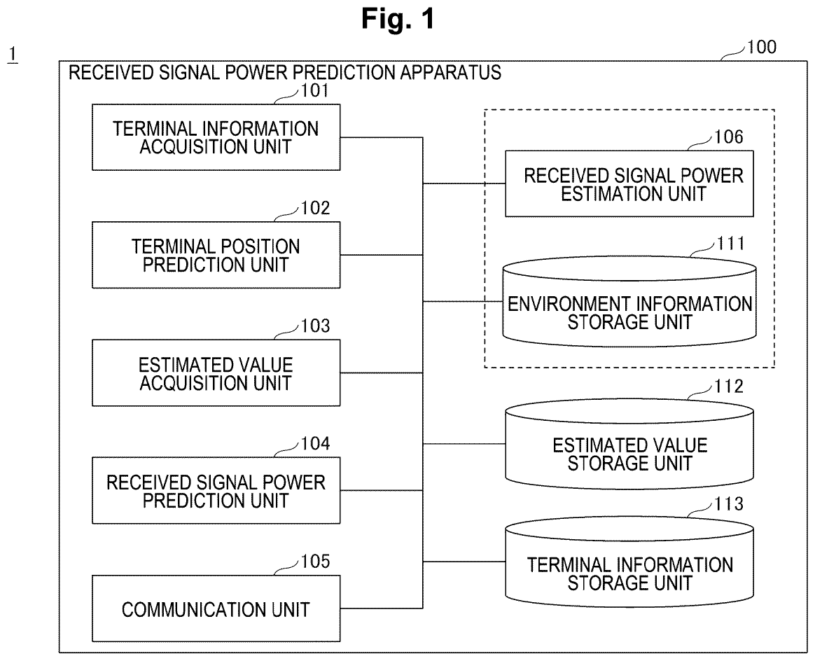

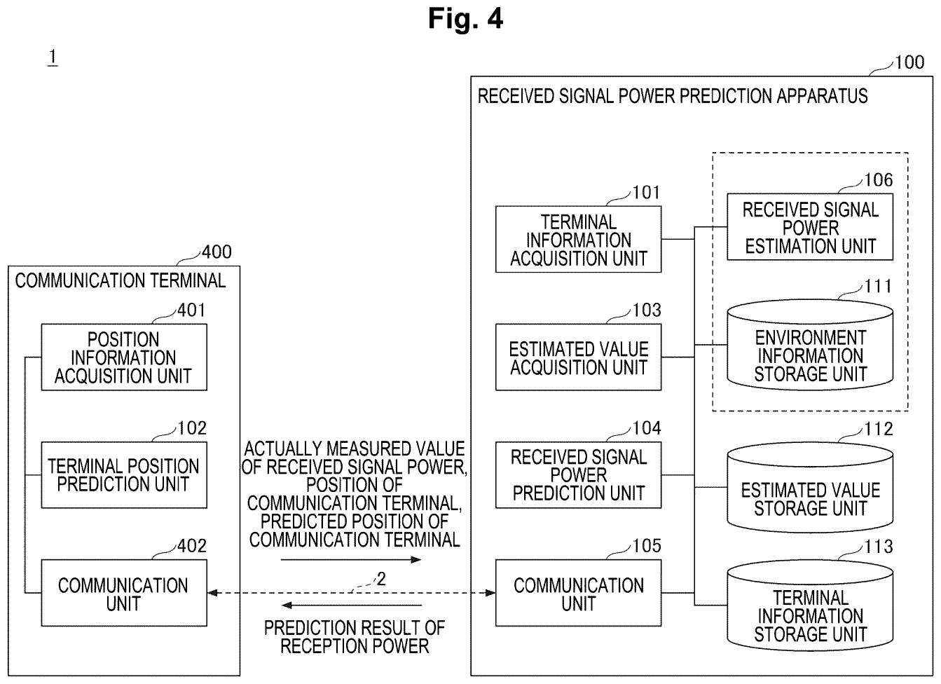

Thus, the received signal power prediction system 1 according to the present embodiment has a system configuration illustrated in FIG. 1 or FIG. 4, for example, so that the received signal power received by the communication terminal 1402 can be predicted in consideration of blocking of radio waves by the moving object in the dynamic environment 1500 where the moving object exists.

### (System Configuration 1)

FIG. 1 is a view illustrating an example of a system configuration of the received signal power prediction system according to the present embodiment. In the example of FIG. 1, the received signal power prediction system 1 is implemented by a received signal power prediction apparatus 100.

The received signal power prediction apparatus 100 is an information processing device having a configuration of a computer or a system including a plurality of computers. The received signal power prediction apparatus 100 implements functional configurations of a terminal information acquisition unit 101, a terminal position prediction unit 102, an estimated value acquisition unit 103, a received signal power prediction unit 104, a communication unit 105, a received signal power estimation unit 106, and the like, by executing a predetermined program on a computer included in the received signal power prediction apparatus 100. At least some of the functional configurations described above may be implemented by hardware.

In addition, the received signal power prediction apparatus 100 implements, for example, an environment information storage unit 111, an estimated value storage unit 112, a terminal information storage unit 113, and the like, by a storage device, a memory, and the like, included in the received signal power prediction apparatus 100. Note that the received signal power prediction apparatus 100 includes the received signal power estimation unit 106 and the environment information storage unit 111 as an example. The received signal power estimation unit 106 and the environment information storage unit 111 may be implemented by an information processing device outside the received signal power prediction apparatus 100 or the received signal power prediction system 1, or by the like.

The terminal information acquisition unit 101 executes terminal information acquisition processing for acquiring terminal information including information such as an actually measured value of received signal power of a communication terminal that is a prediction target and a position of the communication terminal. For example, the received signal power prediction apparatus 100 can communicate with the communication terminal for which received signal power is to be predicted via a communication network. In addition, the communication terminal adds terminal information including an actually measured value of received signal power received from a base station, a position of the own terminal, and the like, measured by the own terminal and transmits request information for requesting acquisition of a predicted value of the received signal power to the received signal power prediction apparatus 100. In this case, the terminal information acquisition unit 101 acquires information such as the actually measured value of the received signal power of the communication terminal and the position of the communication terminal from the request information received by the communication unit 105 from the communication terminal.

Based on the position of the communication terminal included in the terminal information acquired by the terminal information acquisition unit 101, the terminal position prediction unit 102 executes terminal position prediction processing of predicting a predicted position of the communication terminal after a predetermined period (t seconds) has elapsed from a current time point. For example, the position information acquisition unit 401 stores (accumulates) the terminal information acquired from the communication terminal in the terminal information storage unit 113. In addition, the terminal position prediction unit 102 predicts the position of the communication terminal after the predetermined period has elapsed by linear prediction, or the like, for example, based on history of the position of the communication terminal stored in the terminal information storage unit 113.

As another example, the terminal position prediction unit 102 may be included in the communication terminal. In this case, the terminal position prediction unit 102 of the communication terminal calculates the predicted position of the communication terminal after the predetermined period (t seconds) has elapsed from a current position of the communication terminal and movement (moving direction, moving speed, etc.) of the communication terminal measured by a sensor such as an acceleration sensor or an angle sensor. In this case, the communication terminal adds the calculated predicted position after the predetermined period has elapsed to the terminal information and transmits request information for requesting acquisition of a predicted value of received signal power to the received signal power prediction apparatus 100.

The estimated value acquisition unit 103 executes estimated value acquisition processing of acquiring an estimated value of the received signal power at the predicted position of the communication terminal predicted by the terminal position prediction unit 102. As an example, the estimated value storage unit 112 of the received signal power prediction apparatus 100 stores in advance estimated values of received signal power calculated (or measured) in advance at a plurality of evaluation points. In this case, the estimated value acquisition unit 103 acquires, for example, an estimated value of received signal power at an evaluation point closest to the predicted position of the communication terminal from the estimated value storage unit 112. Alternatively, the estimated value acquisition unit 103 may calculate the estimated value of the received signal power at the predicted position of the communication terminal by linear interpolation, or the like, from the estimated values of the received signal power at a plurality of evaluation points around the predicted position of the communication terminal.

As another example, the received signal power prediction apparatus 100 may acquire the estimated value of the received signal power from the received signal power estimation unit 106 that estimates the estimated value of the received signal power at the predicted position of the communication terminal based on static environment information stored in advance in the environment information storage unit 111 and the position of the base station.

The received signal power prediction unit 104 executes received signal power prediction processing of predicting the received signal power of the communication terminal after the predetermined period has elapsed using the actually measured value of the received signal power of the terminal device acquired by the terminal information acquisition unit 101 and the estimated value of the received signal power acquired by the estimated value acquisition unit 103. As an example, the received signal power prediction unit 104 predicts the received signal power of the communication terminal after the predetermined period has elapsed by using a time-series prediction method such as a recurrent neural network (RNN), for example, that uses time-series data of the actually measured value of the received signal power and time-series data of the estimated value of the received signal power.

As another example, the received signal power prediction unit 104 may predict the received signal power of the communication terminal after the predetermined period has elapsed using the time-series prediction method such as the RNN using the time-series data of the actually measured value of the received signal power and the estimated value of the received signal power after the predetermined period has elapsed.

The communication unit 105 executes communication processing of communicating with the communication terminal via the base station, and the like, included in the communication network.

The received signal power estimation unit 106 executes received signal power estimation processing of estimating estimated values of the received signal power at a plurality of evaluation points based on static environment information stored in advance in the environment information storage unit 111 and the position of the base station.

The environment information storage unit 111 stores in advance static environment information of an area for which received signal power is to be predicted. The estimated value storage unit 112 stores the estimated values of the received signal power at the plurality of evaluation points estimated by the received signal power estimation unit 106. Note that the estimated value storage unit 112 may store in advance estimated values of the received signal power at the plurality of evaluation points estimated by another information processing device different from the received signal power prediction apparatus 100. The terminal information storage unit 113 stores history of terminal information (actually measured value of the received signal power, position of the communication terminal, and the like) acquired by the terminal information acquisition unit 101.

### (Pre-Processing)

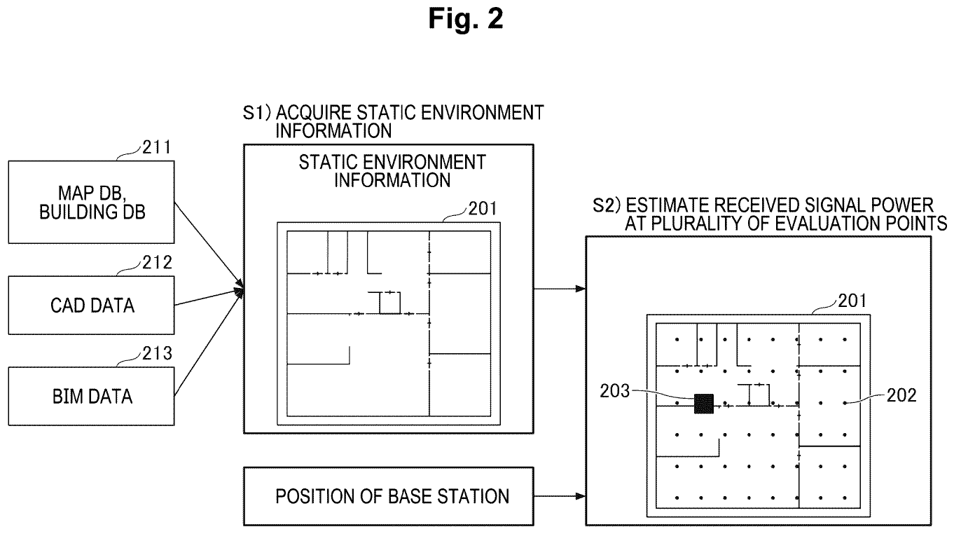

FIG. 2 is a view for explaining pre-processing according to the present embodiment. As an example, the received signal power prediction apparatus 100 stores in advance, in the estimated value storage unit 112, the estimated values of the received signal power at the plurality of evaluation points estimated in the pre-processing as illustrated in FIG. 2. Note that the received signal power estimation unit 106 that performs pre-processing may be included in the received signal power prediction apparatus 100 or may be included in another information processing device different from the received signal power prediction apparatus 100.

The received signal power estimation unit 106 acquires the static environment information from a building database (DB) (or map DB) 211 representing a structure of the building 201, computer aided design (CAD) data 212, building information modeling (BIM) data 213, or the like (step S1).

In addition, the received signal power estimation unit 106 sets a plurality of evaluation points 202 and the position of the base station 203 in a building 201 which is an example of a predetermined area and calculates estimated values of received signal power from the base station 203 at the plurality of evaluation points 202. For example, the received signal power estimation unit 106 calculates the received signal power from the base station 203 at the respective evaluation points 202 using a known radio wave propagation simulation technology such as ray trace. Note that ray trace is also referred to as ray tracing.

Note that the received signal power estimation unit 106 may estimate the estimated values of the received signal power at the plurality of evaluation points 202 using not only ray trace but also other radio wave propagation simulation technologies, an approximate expression based on the actually measured value, or the like. In addition, the estimated values of the received signal power at the plurality of evaluation points 202 stored in the estimated value storage unit 112 may be actually measured values, or the like, of the received signal power at the respective evaluation points 202.

### <Outline of Received Signal Power Prediction Processing>

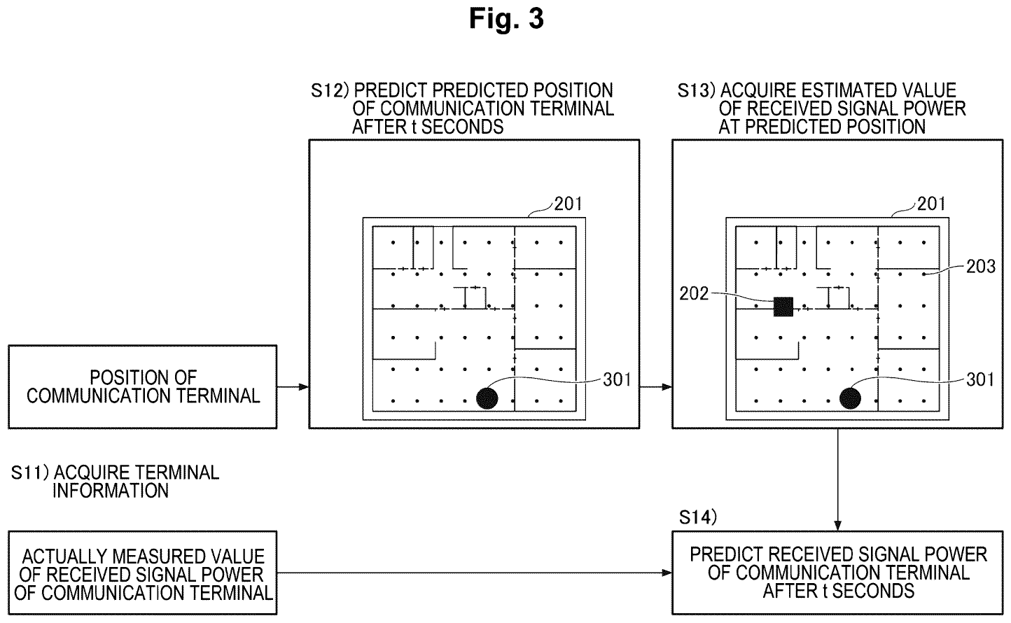

FIG. 3 is a view for explaining outline of received signal power prediction processing according to the present embodiment. This processing indicates outline of the received signal power prediction processing in which the received signal power prediction apparatus 100 predicts received signal power of the communication terminal that is a prediction target after t seconds (after the predetermined period has elapsed).

The terminal information acquisition unit 101 of the received signal power prediction apparatus 100 acquires the terminal information including the actually measured value of the received signal power of the communication terminal, the position of the communication terminal, and the like, from the communication terminal that is a prediction target (step S11).

In addition, the terminal position prediction unit 102 of the received signal power prediction apparatus 100 predicts a predicted position 301 of the communication terminal after t seconds based on the acquired position of the communication terminal (step S12). For example, the position information acquisition unit 401 stores (accumulates) the position of the communication terminal acquired from the communication terminal in the terminal information storage unit 113. Furthermore, the terminal position prediction unit 102 predicts the predicted position 301 of the communication terminal after t seconds by linear prediction, or the like, for example, based on the history of the position of the communication terminal stored in the terminal information storage unit 113.

Subsequently, the estimated value acquisition unit 103 of the received signal power prediction apparatus 100 acquires an estimated value of the received signal power at the predicted position 301 of the communication terminal after t seconds predicted by the terminal position prediction unit 102 (step S13). For example, the estimated value acquisition unit 103 acquires the estimated value of the received signal power corresponding to the predicted position 301 of the communication terminal from the estimated value storage unit 112.

Furthermore, the received signal power prediction unit 104 of the received signal power prediction apparatus 100 predicts the received signal power of the communication terminal after t seconds based on the estimated value of the received signal power acquired by the estimated value acquisition unit 103 and the actually measured value of the received signal power acquired by the terminal information acquisition unit 101 (step S14). For example, the received signal power prediction unit 104 predicts the received signal power of the communication terminal after t seconds (after a predetermined period has elapsed) using a time-series prediction method such as an RNN using the time-series data of the actually measured value of the received signal power and the time-series data of the estimated value of the received signal power. The method of predicting the received signal power by the received signal power prediction unit 104 will be described later in detail.

As described above, the received signal power prediction system 1 according to the present embodiment uses the received signal power estimated based on the static environment information as the estimated value of the received signal power at the predicted position of the communication terminal after the predetermined period has elapsed. In addition, the received signal power prediction system 1 uses the estimated value of the received signal power and the actually measured value of the received signal power indicating dynamic change of the received signal power, thereby predicting the received signal power of the communication terminal after the predetermined period has elapsed in consideration of the dynamic change of the received signal power. By this means, according to the present embodiment, it is possible to provide the received signal power prediction system 1 capable of predicting received signal power of a communication terminal in consideration of blocking of radio waves by a moving object in a dynamic environment where the moving object exists.

Note that the system configuration of the received signal power prediction system 1 illustrated in FIG. 1 is an example. At least some of the functional configurations of the received signal power prediction apparatus 100 may be included in the communication terminal 400.

### (System Configuration 2)

FIG. 4 illustrates another example of a system configuration of the received signal power prediction system according to the present embodiment. In the example of FIG. 4, the received signal power prediction system 1 includes the received signal power prediction apparatus 100 and the communication terminal 400 that can communicate with the received signal power prediction apparatus 100 via a communication network 2.

In the received signal power prediction system 1 illustrated in FIG. 4, not the received signal power prediction apparatus 100 but the communication terminal 400 includes the terminal position prediction unit 102 described in FIG. 1.

The communication terminal 400 is a wireless communication device having a configuration of a computer. The communication terminal 400 implements functional configurations of a position information acquisition unit 401, the terminal position prediction unit 102, a communication unit 402, and the like, by executing a predetermined program on a computer included in the communication terminal 400. At least some of the functional configurations described above may be implemented by hardware.

The position information acquisition unit 401 acquires position information indicating a current position of the communication terminal 400 using, for example, positioning by a global positioning system (GPS) device and autonomous navigation by a sensor such as an acceleration sensor or an angle sensor.

The terminal position prediction unit 102 executes processing of predicting a predicted position of the communication terminal after the predetermined period (t seconds) has elapsed from the current time point on the communication terminal 400 side. For example, the terminal position prediction unit 102 predicts the position of the communication terminal 400 after the predetermined period has elapsed by linear prediction, or the like, for example, based on the history of the position of the communication terminal 400 acquired by the position information acquisition unit 401.

Alternatively, the terminal position prediction unit 102 may calculate the predicted position of the communication terminal 400 after the predetermined period (t seconds) has elapsed from a current position of the communication terminal 400 and movement (moving direction, moving speed, etc.) of the communication terminal measured by a sensor such as an acceleration sensor or an angle sensor.

The communication unit 402 is connected to the communication network 2 by predetermined wireless communication such as fifth generation (5G) or long term evolution (LTE), for example, and executes communication processing of communicating with the received signal power prediction apparatus 100, or the like. For example, the communication unit 402 adds terminal information including an actually measured value of the received signal power of the communication terminal 400, the position of the communication terminal, the predicted position of the communication terminal after the predetermined period has elapsed, and the like, to request information for requesting the received signal power prediction apparatus 100 to predict the received signal power and transmits the request information to the received signal power prediction apparatus 100. Furthermore, the communication unit 402 receives the prediction result of the received signal power transmitted by the received signal power prediction apparatus 100.

In the example of FIG. 4, in the received signal power prediction apparatus 100, the request information to be received by the communication unit 105 from the communication terminal 400 includes information such as the actually measured value of the received signal power of the communication terminal 400, the position of the communication terminal 400, and the predicted position of the communication terminal 400 after the predetermined period has elapsed. Thus, the received signal power prediction apparatus 100 does not have to include the terminal position prediction unit 102, or the like.

As described above, each functional configuration included in the received signal power prediction apparatus 100 described with reference to FIG. 1 only requires to be included in the received signal power prediction system 1 and may be included in other devices in the system.

### <Processing Flow>

Next, processing flow of a received signal power prediction method according to the present embodiment will be described by exemplifying a plurality of examples.

### Example 1

### (Pre-Processing)

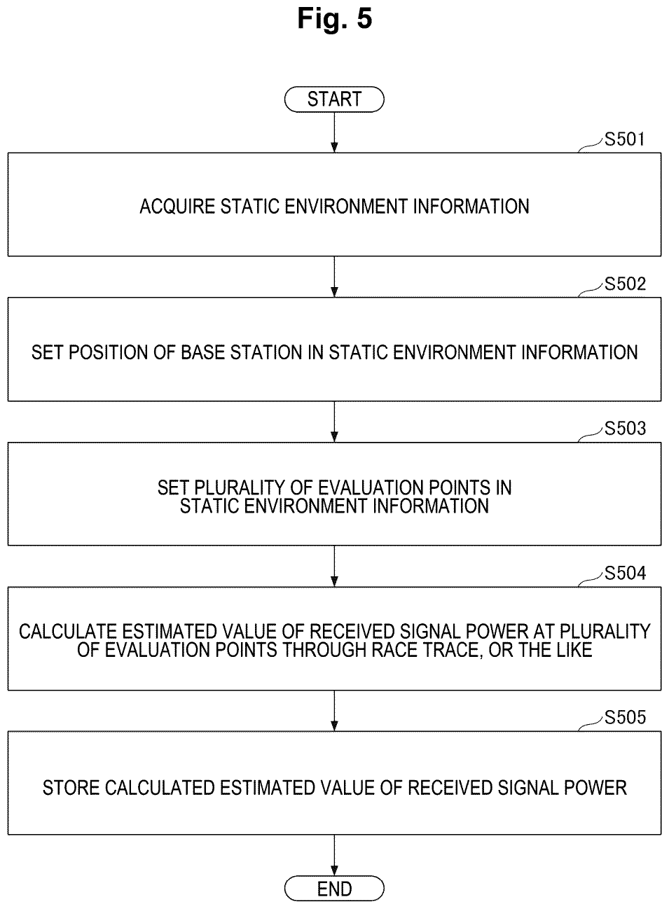

FIG. 5 is a flowchart indicating an example of pre-processing according to Example 1. This processing indicates an example of specific processing of the pre-processing described in FIG. 2.

In step S501, the received signal power estimation unit 106 acquires static environment information of a predetermined area from the building DB (or map DB) 311, the CAD data 312, the BIM data 313, or the like. The static environment information includes, for example, three-dimensional coordinate information indicating a position of an object that basically does not move, such as a building, a wall, or a floor, or the like.

In step S502, for example, as illustrated in FIG. 2, the received signal power estimation unit 106 sets the position of the base station 203 in static environment information of the predetermined area.

In step S503, for example, as illustrated in FIG. 2, the received signal power estimation unit 106 planarly sets a plurality of evaluation points 202 in the static environment information of the predetermined area.

In step S504, the received signal power estimation unit 106 calculates estimated values of the received signal power at the plurality of evaluation points 202 by radio wave propagation estimation such as ray trace. In the ray trace, a state in which radio waves (rays) transmitted from a transmission point are reflected or diffracted by a structure on the way and reach a reception point is traced as a locus of the respective rays, and power of all the rays that have reached the reception point is added to calculate intensity of the radio waves at the reception point.

In step S505, the received signal power estimation unit 106 stores the calculated estimated values of the received signal power at the plurality of evaluation points 202 in a storage unit such as the estimated value storage unit 112, for example.

By the processing in FIG. 5, the received signal power estimation unit 106 can acquire the estimated values of the received signal power at the plurality of evaluation points 202 stored in the estimated value storage unit 112.

### (Received Signal Power Prediction Processing)

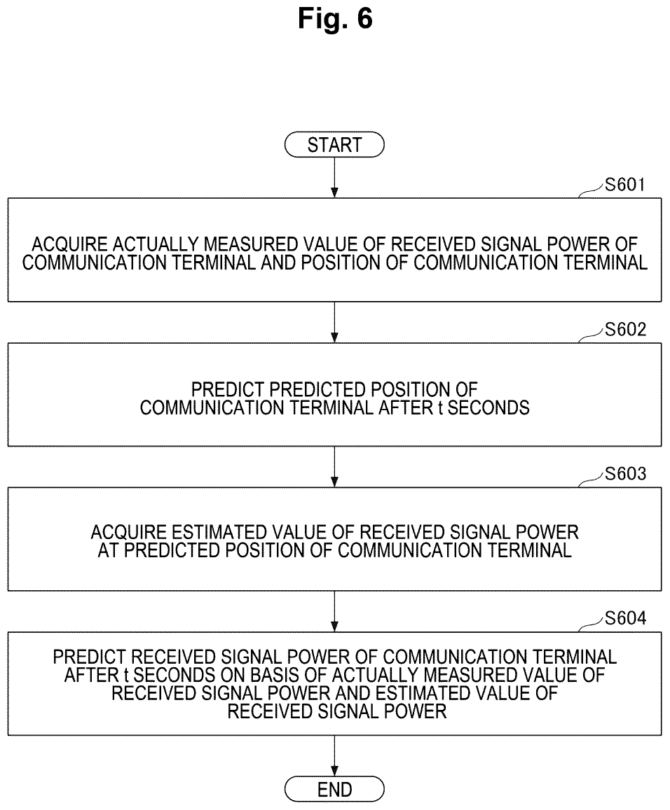

FIG. 6 is a flowchart indicating an example of received signal power prediction processing according to Example 1. This processing indicates an example of the received signal power prediction processing to be executed by the received signal power prediction system 1 having the functional configurations illustrated in FIG. 1 or 4, for example. Note that, at the start of the processing indicated in FIG. 6, the estimated value storage unit 112 stores the estimated values of the received signal power at the plurality of evaluation points 202 estimated in the processing in FIG. 5.

In step S601, the terminal information acquisition unit 101 acquires the actually measured value of the received signal power of the communication terminal that is a prediction target and the position of the communication terminal. For example, the terminal information acquisition unit 101 acquires the actually measured value of the received signal power included in the terminal information transmitted from the communication terminal to the received signal power prediction apparatus 100 and the position of the communication terminal.

In step S602, the terminal position prediction unit 102 predicts a predicted position of the communication terminal after t seconds (after the predetermined period has elapsed). For example, the terminal position prediction unit 102 stores history of the position of the communication terminal acquired by the terminal information acquisition unit 101 in the terminal information storage unit 113. In addition, the terminal position prediction unit 102 predicts the predicted position of the communication terminal after the predetermined period has elapsed by linear prediction, or the like, for example, based on the history of the position of the communication terminal stored in the terminal information storage unit 113.

In step S603, the estimated value acquisition unit 103 acquires an estimated value of the received signal power at the predicted position of the communication terminal. For example, the estimated value acquisition unit 103 acquires the estimated value of the received signal power corresponding to the predicted position of the communication terminal from the estimated value storage unit 112.

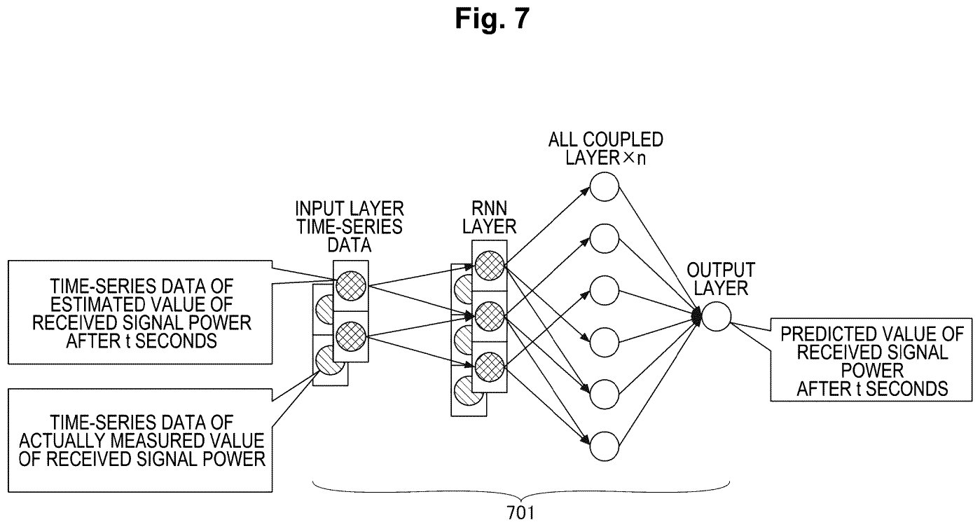

In step S604, the received signal power prediction unit 104 predicts the received signal power of the communication terminal after t seconds based on the actually measured value of the received signal power of the communication terminal acquired by the terminal information acquisition unit 101 and the estimated value of the received signal power after t seconds acquired by the estimated value acquisition unit 103. For example, as illustrated in FIG. 7, the received signal power prediction unit 104 inputs time-series data of the estimated value of the received signal power after t seconds and time-series data of the actually measured value of the received signal power to a recurrent neural network (RNN) 701 and obtains the predicted value of the received signal power after t seconds.

Here, the RNN 701 is a neural network (NN) that can handle time-series data as input data. The RNN 701 performs machine learning in advance using, for example, the time-series data of the estimated value of the received signal power after t seconds and the time-series data of the actually measured value of the received signal power as input data and using the actually measured value of the received signal power after t seconds as ground-truth data.

The received signal power prediction unit 104 can obtain the predicted value of the received signal power after t seconds by inputting the time-series data of the estimated value of the received signal power after t seconds and the time-series data of the actually measured value of the received signal power to the learned RNN 701.

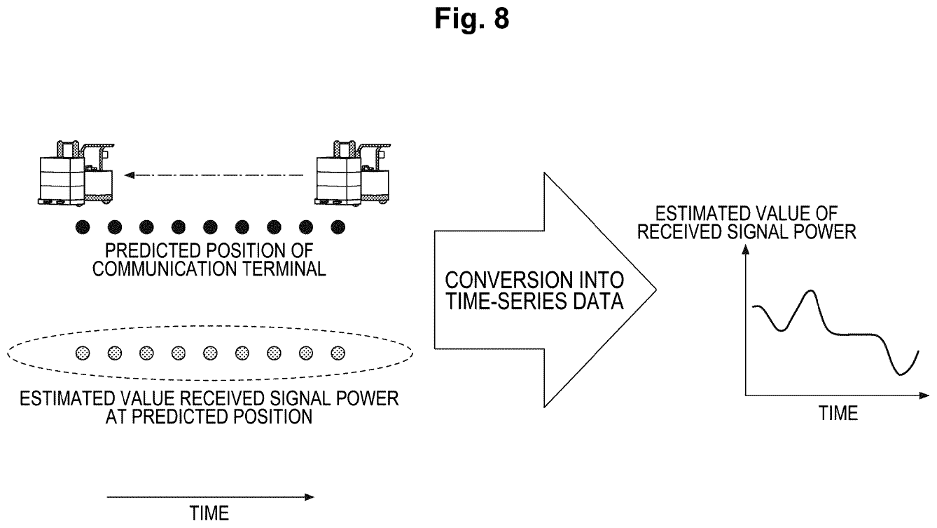

Here, the time-series data of the estimated value of the received signal power after t seconds can be obtained, for example, by converting the estimated values of the received signal power at a plurality of predicted positions acquired by the estimated value acquisition unit 103 into time-series data based on a plurality of predicted positions of the communication terminal after t seconds as illustrated in FIG. 8.

In addition, as the time-series data of the actually measured value of the received signal power, for example, the actually measured value of the received signal power periodically transmitted from the communication terminal is stored in the terminal information storage unit 113, and the actually measured value of the received signal power stored in the terminal information storage unit 113 can be used as the time-series data of the actually measured value of the received signal power.

As another example, when the request information for requesting prediction of the received signal power after t seconds is transmitted to the received signal power prediction apparatus 100, the communication terminal may add and transmit the time-series data of the actually measured value of the received signal power, the time-series data of the position of the communication terminal, and the like. In this case, the received signal power prediction apparatus 100 may obtain the time-series data of the predicted position of the communication terminal and the time-series data of the estimated value of the received signal power at each predicted position as illustrated in FIG. 8 based on the time-series data of the position of the communication terminal.

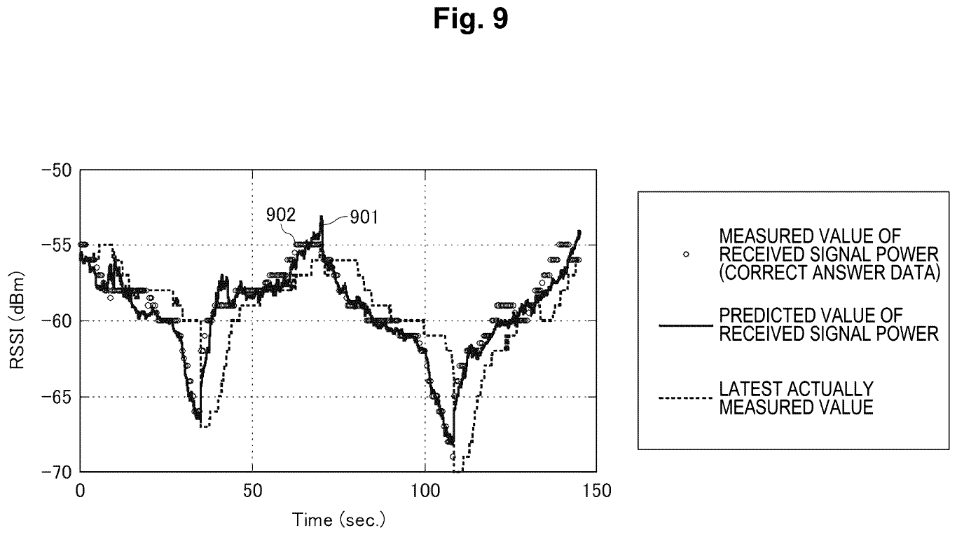

FIG. 9 illustrates an example of a prediction result of received signal power after the predetermined period has elapsed according to the present embodiment. The example of FIG. 9 indicates, in an area where an obstacle such as a moving object exists, a predicted value 901 of the received signal power after five seconds predicted by the received signal power prediction system 1 and the measured value (ground-truth data 902) of the received signal power actually measured after five seconds. As described above, the received signal power prediction system 1 according to the present embodiment can accurately predict the received signal power after five seconds even if an obstacle exists.

### Example 2

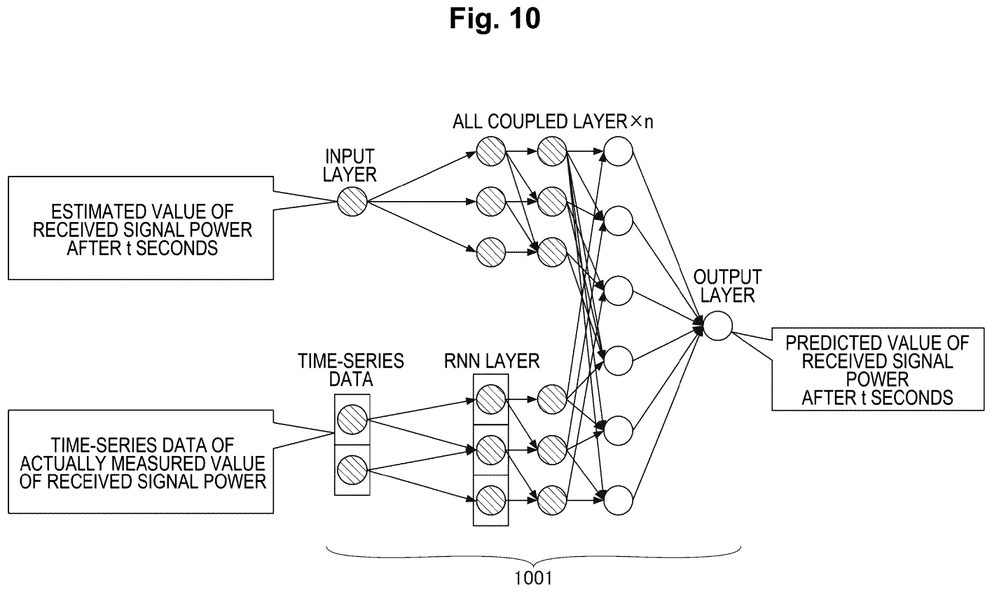

The received signal power prediction unit 104 may predict the received signal power after a predetermined period has elapsed using an RNN 1001 as illustrated in FIG. 10 instead of the RNN 701 described in FIG. 7.

In the example of FIG. 10, the estimated value of the received signal power after t seconds is not used as the time-series data, and the estimated value of the received signal power at the predicted position of the communication terminal after t seconds is used as the input data. As described above, the received signal power prediction unit 104 may predict the received signal power of the communication terminal after the predetermined period has elapsed using a time-series prediction method such as the RNN using the time-series data of the actually measured value of the received signal power and the estimated value of the received signal power after the predetermined period has elapsed.

### Example 3

In Examples 1 and 2, the estimated values of the received signal power at the plurality of evaluation points are stored in advance in the estimated value storage unit 112 by the pre-processing. In Example 3, an example of processing in a case where pre-processing is not performed will be described.

### (Received Signal Power Prediction Processing)

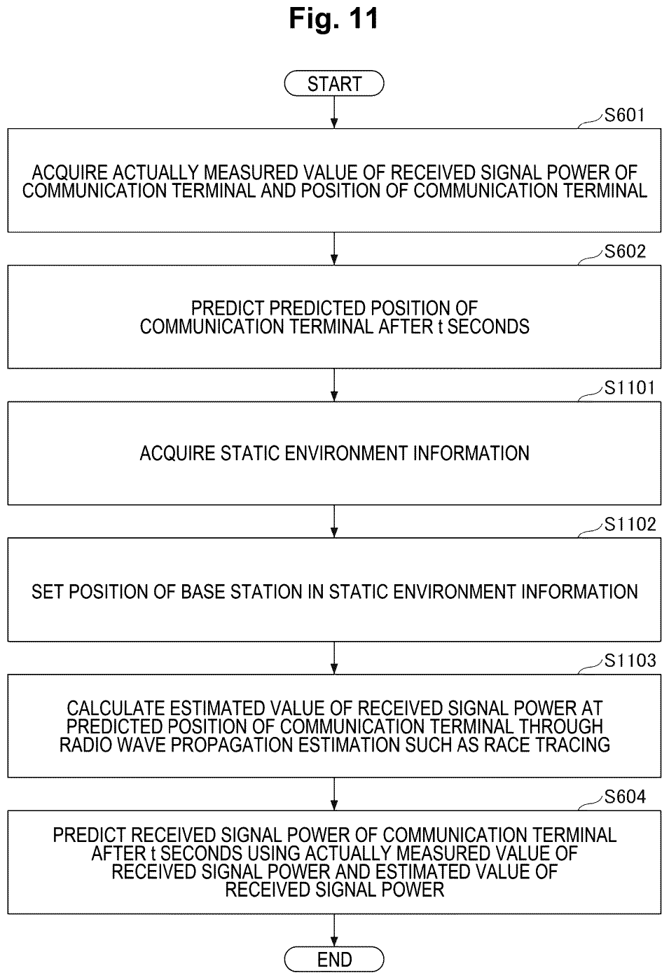

FIG. 11 is a flowchart indicating an example of received signal power prediction processing according to Example 3. This processing indicates another example of the received signal power prediction processing to be executed by the received signal power prediction system 1 as illustrated in FIG. 1 or 4, for example.

Note that, among the processing illustrated in FIG. 11, the processing in steps S601, S602, and S604 may be similar to the received signal power prediction processing according to Example 1 described with reference to FIG. 6. The received signal power prediction system 1 according to Example 3 executes the processing in steps S1101 to S1103 in FIG. 11 instead of the processing in step S603 in FIG. 6.

In step S1101, the received signal power estimation unit 106 acquires static environment information of a predetermined area for which received signal power is to be predicted from the environment information storage unit 111, or the like.

In step S1102, the received signal power estimation unit 106 sets the position of the base station in the acquired environment information.

In step S1103, the received signal power estimation unit 106 calculates an estimated value of the received signal power at the predicted position of the communication terminal after t seconds by, for example, radio wave propagation estimation such as ray trace. As a result, the estimated value acquisition unit 103 according to Example 3 can acquire the estimated value of the received signal power at the predicted position of the communication terminal after t seconds from the received signal power estimation unit 106 instead of the estimated value storage unit 112.

As described above, the received signal power prediction system 1 may predict the predicted value of the received signal power of the communication terminal after the predetermined period has elapsed without performing pre-processing.

### Hardware Configuration Example

### <Hardware Configuration of Received Signal Power Prediction Apparatus>

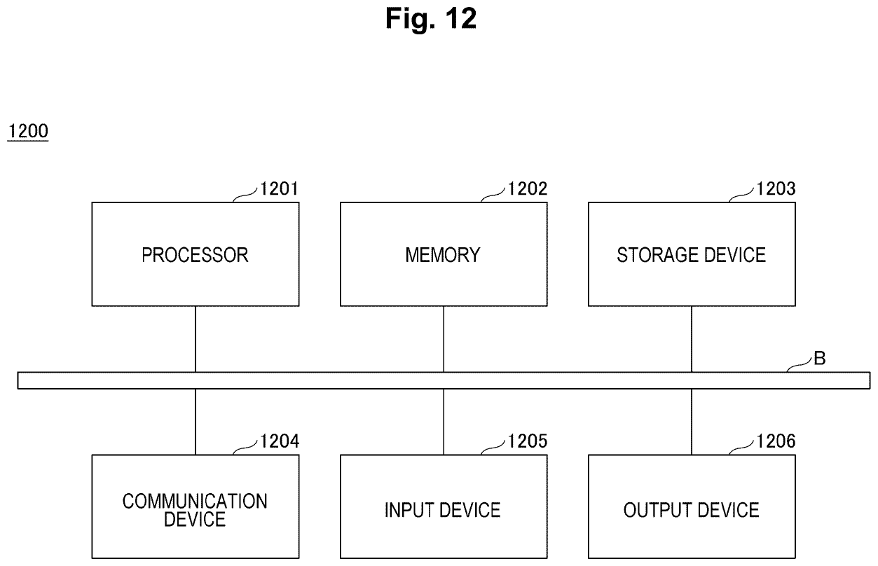

FIG. 12 is a view illustrating an example of a hardware configuration of the prediction apparatus according to the present embodiment. The received signal power prediction apparatus 100 includes, for example, a configuration of a computer 1200 as illustrated in FIG. 12. In the example of FIG. 12, the computer 1200 includes a processor 1201, a memory 1202, a storage device 1203, a communication device 1204, an input device 1205, an output device 1206, a bus B, and the like.

The processor 1201 is, for example, an arithmetic device such as a central processing unit (CPU) that implements various functions by executing a predetermined program. The memory 1202 is a storage medium readable by the computer 1200 and includes, for example, a random access memory (RAM), a read only memory (ROM), and the like. The storage device 1203 is a computer-readable storage medium and can include, for example, a hard disk drive (HDD), a solid state drive (SSD), various optical disks, and a magneto-optical disk.

The communication device 1204 includes one or more pieces of hardware (communication device) for communicating with other devices via a wireless or wired network. The input device 1205 is an input device (for example, a keyboard, a mouse, a microphone, a switch, a button, a sensor, or the like) that receives an input from the outside. The output device 1206 is an output device (for example, a display, a speaker, an LED lamp, or the like) that performs output to the outside. Note that the input device 1205 and the output device 1206 may be integrated (for example, may be an input/output device such as a touch panel display).

The bus B is commonly connected to the above-described components and transmits, for example, an address signal, a data signal, various control signals, and the like. Note that the processor 1201 is not limited to the CPU and may be, for example, a digital signal processor (DSP), a programmable logic device (PLD), a field programmable gate array (FPGA), or the like.

### (Hardware Configuration of Communication Terminal)

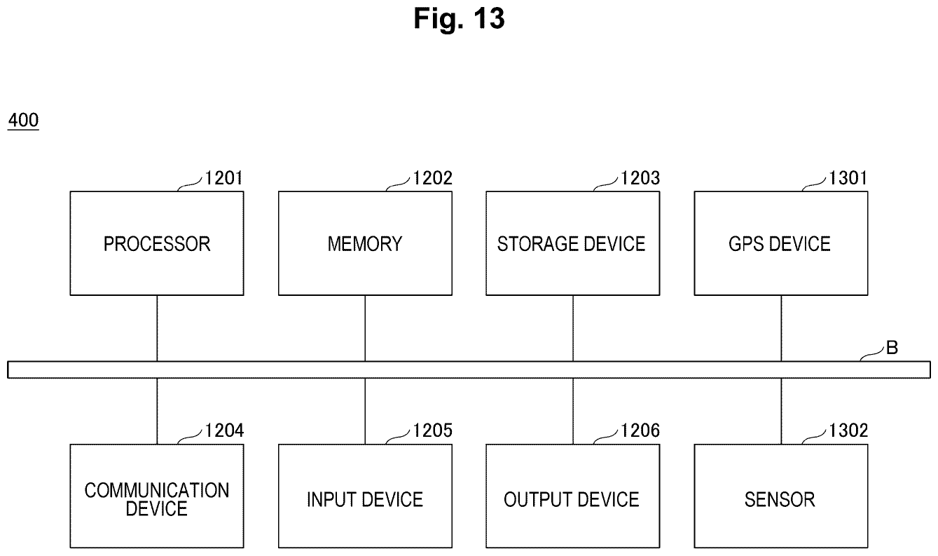

FIG. 13 is a view illustrating an example of a hardware configuration of the communication terminal according to the present embodiment. The communication terminal 400 includes, for example, a GPS device 1301, a sensor 1302, and the like, in addition to the hardware configuration of the computer 1200 described with reference to FIG. 12.

The GPS device 1301 is a positioning device that receives a positioning signal transmitted from a GPS satellite and outputs position information indicating a current position of the communication terminal 400. The sensor 1302 is, for example, a detection device that detects movement of the communication terminal 400, such as an acceleration sensor or an angle sensor.

### Supplementary Note

The received signal power prediction apparatus 100 and the communication terminal 400 in the present embodiment are not limited to be implemented by a dedicated device and may be implemented by a general-purpose computer. In that case, a program for implementing this function may be recorded in a computer-readable recording medium, and the program recorded in the recording medium may be read and executed by a computer system to implement this function. Note that the “computer system” here includes hardware such as an OS and peripheral devices.

In addition, the “computer-readable recording medium” includes various storage devices such as a portable medium such as a flexible disk, a magneto-optical disk, a ROM, and a CD-ROM, and a hard disk built in a computer system. Furthermore, the “computer-readable recording medium” may include a medium that dynamically holds a program for a short period of time, such as a communication line in a case where the program is transmitted via a network such as the Internet or a communication line such as a telephone line, and a medium that holds a program for a certain period of time, such as a volatile memory inside a computer system serving as a server or a client in that case.

In addition, the program may be provided for implementing part of the above-described functions, may be capable of implementing the above-described functions in combination with a program already recorded in a computer system or may be implemented by using hardware such as a programmable logic device (PLD) or a field programmable gate array (FPGA).

### Effects of Embodiment

According to the present embodiment, it is possible to provide the received signal power prediction system 1 capable of predicting received signal power of a communication terminal in consideration of blocking of radio waves by a moving object in a dynamic environment where the moving object exists.

Specifically, the received signal power prediction system 1 according to the present embodiment uses received signal power estimated based on static environment information as an estimated value of received signal power at a predicted position of the communication terminal after a predetermined period has elapsed. In addition, the received signal power prediction system 1 uses the estimated value of the received signal power and the actually measured value of the received signal power indicating dynamic change of the received signal power, thereby predicting the received signal power of the communication terminal after the predetermined period has elapsed in consideration of the dynamic change of the received signal power. By this means, according to the received signal power prediction system 1 according to the present embodiment, it is possible to predict received signal power of a communication terminal in consideration of blocking of radio waves by a moving object in a dynamic environment where the moving object exists.

In addition, according to the above effect, in a wireless communication system, it is possible to stably use wireless communications or applications even when the communication quality deteriorates, by switching an accommodation destination (wireless base station) of a communication terminal or controlling a communication parameter, by changing a traveling route in an autonomous driving vehicle, or the like.

### Summary of Embodiment

The present specification discloses at least the following received signal power prediction system, received signal power prediction apparatus, received signal power prediction method, and program.

### (Clause 1)

A received signal power prediction system that predicts received signal power of a communication terminal after a predetermined period has elapsed, the received signal power prediction system including:
a terminal information acquisition unit configured to acquire an actually measured value of received signal power of the communication terminal and a position of the communication terminal;
a terminal position prediction unit configured to predict a predicted position of the communication terminal after the predetermined period has elapsed based on the position of the communication terminal;
an estimated value acquisition unit configured to acquire an estimated value of received signal power at the predicted position of the communication terminal; and
a received signal power prediction unit configured to predict the received signal power of the communication terminal after the predetermined period has elapsed using the actually measured value of the received signal power and the estimated value of the received signal power.

### (Clause 2)

The received signal power prediction system according to clause 1, in which the received signal power prediction unit predicts the received signal power of the communication terminal after the predetermined period has elapsed by using a time-series prediction method that uses time-series data of the actually measured value of the received signal power and time-series data of the estimated value of the received signal power.

### (Clause 3)

The received signal power prediction system according to clause 1, in which the received signal power prediction unit predicts the received signal power of the communication terminal after the predetermined period has elapsed by using a time-series prediction method that uses time-series data of the actually measured value of the received signal power and the estimated value of the received signal power after the predetermined period has elapsed.

### (Clause 4)

The received signal power prediction system according to any one of clauses 1 to 3, in which the estimated value acquisition unit acquires the estimated value of the received signal power at the predicted position of the communication terminal from a storage unit that stores in advance received signal power calculated or measured at a plurality of evaluation points.

### (Clause 5)

The received signal power prediction system according to any one of clauses 1 to 3, in which the estimated value acquisition unit acquires the estimated value of the received signal power at the predicted position of the communication terminal from a received signal power estimation unit that estimates the estimated value of the received signal power at the predicted position of the communication terminal based on static environment information and a position of a base station.

### (Clause 6)

A received signal power prediction apparatus that predicts received signal power of a communication terminal after a predetermined period has elapsed, the received signal power prediction apparatus including:
a terminal information acquisition unit configured to acquire an actually measured value of received signal power of the communication terminal and a position of the communication terminal;
a terminal position prediction unit configured to predict a predicted position of the communication terminal after the predetermined period has elapsed based on the position of the communication terminal;
an estimated value acquisition unit configured to acquire an estimated value of received signal power at the predicted position of the communication terminal; and
a received signal power prediction unit configured to predict the received signal power of the communication terminal after the predetermined period has elapsed using a time-series prediction method using the actually measured value of the received signal power and the estimated value of the received signal power.

### (Clause 7)

A received signal power prediction method to be executed by a received signal power prediction system that predicts received signal power of a communication terminal after a predetermined period has elapsed, the received signal power prediction method including:
processing of acquiring an actually measured value of received signal power of the communication terminal and a position of the communication terminal;
processing of predicting a predicted position of the communication terminal after the predetermined period has elapsed based on the position of the communication terminal;
processing of acquiring an estimated value of received signal power at the predicted position of the communication terminal; and
processing of predicting the received signal power of the communication terminal after the predetermined period has elapsed using a time-series prediction method using the actually measured value of the received signal power and the estimated value of the received signal power.

### (Clause 8)

A program for causing a computer to execute the received signal power prediction method according to clause 7.

Although the present embodiment has been described, the present invention is not limited to such a specific embodiment, and various modifications and changes can be made within the scope of the gist of the present invention described in the claims.

### REFERENCE SIGNS LIST

1 Received signal power prediction system
100 Received signal power prediction apparatus
101 Terminal information acquisition unit
102 Terminal position prediction unit
103 Estimated value acquisition unit
104 Received signal power prediction unit
106 Received signal power estimation unit
112 Estimated value storage unit (storage unit)
400 Communication terminal
1200 Computer

1. A received signal power prediction system comprising:
a received signal power prediction apparatus that predicts received signal power of a communication terminal after a predetermined period has elapsed; and
the communication terminal, which can communicate with the received signal power prediction apparatus via a communication network, wherein
the received signal power prediction apparatus includes a first memory; and a first processor coupled to the first memory,
the communication terminal includes a second memory; and a second processor coupled to the second memory,
the first processor is configured to acquire an actually measured value of received signal power of the communication terminal and a position of the communication terminal;
the second processor is configured to predict a predicted position of the communication terminal after the predetermined period has elapsed based on the position of the communication terminal;
the first processor is configured to acquire an estimated value of received signal power at the predicted position of the communication terminal; and
the first processor is configured to predict the received signal power of the communication terminal after the predetermined period has elapsed using the actually measured value of the received signal power and the estimated value of the received signal power.

2. The received signal power prediction system according to claim 1, wherein the first processor predicts the received signal power of the communication terminal after the predetermined period has elapsed by using a time-series prediction method that uses time-series data of the actually measured value of the received signal power and time-series data of the estimated value of the received signal power.

3. The received signal power prediction system according to claim 1, wherein the first processor predicts the received signal power of the communication terminal after the predetermined period has elapsed by using a time-series prediction method that uses time-series data of the actually measured value of the received signal power and the estimated value of the received signal power after the predetermined period has elapsed.

4. The received signal power prediction system according to claim 1, wherein the first processor acquires the estimated value of the received signal power at the predicted position of the communication terminal from a storage that stores in advance received signal power calculated or measured at a plurality of evaluation points.

5. The received signal power prediction system according to claim 1, wherein the first processor estimates the estimated value of the received signal power at the predicted position of the communication terminal based on static environment information and a position of a base station.

6. A received signal power prediction apparatus that predicts received signal power of a communication terminal after a predetermined period has elapsed, the received signal power prediction apparatus comprising:
a memory; and
a processor coupled to the memory and configured to:
acquire an actually measured value of received signal power of the communication terminal and a position of the communication terminal;
predict a predicted position of the communication terminal after the predetermined period has elapsed based on the position of the communication terminal;
acquire an estimated value of received signal power at the predicted position of the communication terminal; and
predict the received signal power of the communication terminal after the predetermined period has elapsed using the actually measured value of the received signal power and the estimated value of the received signal power.

7. A received signal power prediction method to be executed by a received signal power prediction system that predicts received signal power of a communication terminal after a predetermined period has elapsed, the received signal power prediction method comprising:
acquiring an actually measured value of received signal power of the communication terminal and a position of the communication terminal;
predicting a predicted position of the communication terminal after the predetermined period has elapsed based on the position of the communication terminal;
acquiring an estimated value of received signal power at the predicted position of the communication terminal; and
predicting the received signal power of the communication terminal after the predetermined period has elapsed using the actually measured value of the received signal power and the estimated value of the received signal power.

8. A non-transitory computer-readable recording medium storing a program for causing a computer to perform the received signal power prediction method of claim 7.

9. The received signal power prediction apparatus according to claim 6, wherein the processor predicts the received signal power of the communication terminal after the predetermined period has elapsed by using a time-series prediction method that uses time-series data of the actually measured value of the received signal power and time-series data of the estimated value of the received signal power.

10. The received signal power prediction apparatus according to claim 6, wherein the processor predicts the received signal power of the communication terminal after the predetermined period has elapsed by using a time-series prediction method that uses time-series data of the actually measured value of the received signal power and the estimated value of the received signal power after the predetermined period has elapsed.

11. The received signal power prediction apparatus according to claim 6, wherein the processor acquires the estimated value of the received signal power at the predicted position of the communication terminal from a storage that stores in advance received signal power calculated or measured at a plurality of evaluation points.

12. The received signal power prediction apparatus according to claim 6, wherein the processor estimates the estimated value of the received signal power at the predicted position of the communication terminal based on static environment information and a position of a base station.
